(19) United States
(12) Patent Application Publication
(10) Pub. No.: US 2010/0089226 A1
(43) Pub. Date: Apr. 15, 2010

(54) Remote Monitoring And Munitions Deployment System

(76) Inventors: Kenneth R. Jones, Wayne, NJ (US); Edward M. Ulicki, Upper Saddle River, NJ (US); Frank J. Dindl, Newton, NJ (US)

Correspondence Address: TOWNSEND & BANTA;c/o PORTFOLIO IP, PO BOX 52050, MINNEAPOLIS, MN, 55402, US

(21) Appl. No.: 12/419,295

(22) Filed: Apr. 7, 2009

Related U.S. Application Data
(60) Provisional application No. 61/123,301, filed on Apr. 7, 2008.

(51) Int. Cl. F41H 11/00; F41H 13/00; G06G 7/80; G06F 19/00

(52) U.S. Cl. 89/1.1; 235/400

(57) ABSTRACT

A system for remotely monitoring an environment and selectively deploying munitions is provided. The system is comprised of sensors to monitor one or more select environments, one or more munitions deployment devices disposed in the selected environment, and an operator control unit (OCU) operable to communicate with the munitions deployment device(s) and sensors. Sensor data is communicated to the system, enabling a user to selectively deploy munitions disposed in or in communication with the munitions deployment device(s), based on the threat detected by the sensors. Deployable munitions include both lethal and non-lethal munitions. The munitions deployment devices may be deployed in a stationary location, or in mobile applications, such as on a robotic vehicle, and accommodate removably, electrically initiated munitions cartridges. Further, the deployment devices may be in wired or wireless communication with the system, allowing virtually unlimited scalability.

### RELATED APPLICATION

This is a nonprovisional application of copending corresponding provisional application Ser. No. 61/123, 301, filed Apr. 7, 2008, the contents of which are incorporated herein by reference.

### FIELD OF THE INVENTION

A system capable of remotely monitoring an environment, such as a perimeter of a secure facility or a battlefield, via a stationary or mobile emplacement, and selectively deploying a lethal or non-lethal munition, is provided. In particular, a system enabling a user to monitor intrusion of a selected environment, and selectively deploy an appropriate munition based on the observed threat is provided. In addition, the system is operable to allow a user to escalate the response, e.g., from non-lethal to lethal means, based on changes in the perceived threat.

### BACKGROUND OF THE INVENTION

Perimeter defense has traditionally been achieved by using remotely controlled, permanently disposed lethal munitions. For example, in military applications, claymore style mines and land mines are routinely placed along defensive perimeters. Claymore style mines may be remotely (via a wire) detonated when desired. However, claymore style mines, being lethal or non-lethal, are able to provide merely one means of deterrent or defense after emplacement.

In contrast to claymore style mines, which are remotely controlled by a user, traditional land mines are generally installed where desired, left in place indefinitely, and detonate automatically upon being triggered. Thus, they are non-selective, lethal, and frequently wound or kill non-combatants. Thus, there is currently great international pressure to discontinue the use of such non-selective means of defense.

In view of the above, it is an object of the present invention to provide a means for the deployment of various types of munitions (such as lethal, non-lethal, and/or a combination of both), which may be remotely controlled or automatically programmed to react to threats in any desired manner without interaction of the user.

It is a further object of the present invention to provide a means for the deployment of various types of munitions (such as lethal, non-lethal, and/or a combination of both), which may be remotely controlled or automatically programmed to react to threats in any desired manner without interaction of the user, and which may be deployed in a fixed (stationary) position or on a mobile platform (such as a robotic vehicle).

It is a further object of the present invention to provide a means of selectively deploying such munitions, based on the perceived threat to the environment being protected. For example, if a non-lethal threat to a secured environment is detected, it is an object of the present invention to enable a user to deploy a non-lethal munition. Alternatively, if a lethal threat is detected, it is an object of the present invention to enable a user to select a lethal munition to be deployed against the threat.

It is a further object of the present invention to provide a means of selectively deploying munitions as described above, which may be deactivated upon remote command, thereby eliminating any unintentional infliction of injury.

It is a further object of the present invention to provide a system capable of instituting such means as described above. The system should be capable of being disposed in a stationary position (such as for remote perimeter defense of a secure facility or battlefield), or of being mobiley deployed (such as on a manned or robotic vehicle).

It is a further object of the present invention to provide such as system as described above which is scalable in nature, such that additional munitions deployment means may be added to the system at will.

### SUMMARY OF THE INVENTION

In order to achieve the objects of the invention mentioned above, the present inventors developed a system for remotely monitoring an environment and selectively deploying munitions appropriate for the situation. In particular, in a first embodiment of the present invention, a system for remotely monitoring an environment and selectively deploying munitions is provided, said system comprising:

(a) one or more munitions deployment devices operable to selectively deploy one or more munitions, said munitions deployment means comprising:
(i) a deployment device body;
(ii) munitions containment means disposed in or in communication with the deployment device body;
(iii) a first data receiving and transmission means disposed in or adjacent to the deployment device body;
(iv) a first computer processing means in communication with the first data receiving and transmission means; and
(v) one or more munitions initiation means in communication with the first computer processing means, and in communication with or disposed adjacent to the munitions containment means, so as to be capable of initiating munitions disposed within or in communication with the munitions containment means;

(b) an operator control unit (OCU) comprising:
(i) a second computer processing means;
(ii) a data storage means in communication with the second computer processing means;
(iii) a second data receiving and transmission means in communication with the second computer processing means; and
(iv) a human-computer interface; and

(c) one or more sensors disposed in communication with the munitions deployment device and/or the OCU, said sensors operable to detect one or more of status and changes in environmental conditions and personnel within a detection range of the sensors.

In a second embodiment of the present invention, the system for remotely monitoring an environment and selectively deploying munitions according to the first embodiment above is provided, further comprising:

(d) a video or still camera means in communication with the munitions deployment device and/or OCU,

wherein the video or still camera means is operable to provide photographic and/or video data to the user and/or munitions deployment device.

In a third embodiment of the present invention, the system for remotely monitoring an environment and selectively deploying munitions according to the first embodiment above is provided, further comprising:

an audio and/or video communication means disposed on or in communication with the munitions deployment devices, and in communication with the OCU,

wherein a system user may utilize the audio and/or video communication means to communicate audible and/or visual messages, warnings, etc., to hostile or non-hostile personnel.

In a fourth embodiment of the present invention, the system for remotely monitoring an environment and selectively deploying munitions according to the first embodiment above is provided, wherein the munitions containment means comprises one or more of a launch tube, retaining bracket, mount and ledge.

In a fifth embodiment of the present invention, the system for remotely monitoring an environment and selectively deploying munitions according to the first embodiment above is provided, wherein the first data receiving and transmission means is a wired or wireless data transmitting device.

In a sixth embodiment of the present invention, the system for remotely monitoring an environment and selectively deploying munitions according to the first embodiment above is provided, wherein first and second computer processing means are comprised of any conventional microprocessor (computer processor) and/or logic device.

In a seventh embodiment of the present invention, the system for remotely monitoring an environment and selectively deploying munitions according to the first embodiment above is provided, wherein the munitions initiation means comprises one or more of an electrical initiation means and a mechanical initiation means (such as a firing pin structure), such that the munitions initiation means are controllable by a user via the OCU, or are programmable such that initiation of the munitions disposed in the munitions containment means may be restricted to desired times and/or conditions.

In an eighth embodiment of the present invention, the system for remotely monitoring an environment and selectively deploying munitions according to the first embodiment above is provided, wherein the system comprises a plurality of munitions deployment devices connected in a daisy-chain (serial) configuration, or a plurality of munitions deployment devices in independent communication with the OCU.

In a ninth embodiment of the present invention, the system for remotely monitoring an environment and selectively deploying munitions according to the first embodiment above is provided, wherein the sensors are comprised of one or more of chemical, biological, motion, RADAR, LIDAR, acoustic, seismic, magnetic, mechanical (such as trip wires), laser (light beam) and infrared sensors.

In a tenth embodiment of the present invention, the system for remotely monitoring an environment and selectively deploying munitions according to the first embodiment above is provided, further comprising adapter means capable of adapting the size of the munitions containment means to accommodate a munition having different dimensions than the munitions containment means. For example, where the munitions containment means is a slot which supports a round-shaped munition, an adapter is provided which can support fielded rounds, such as 40 mm grenades, and enable them to be fitted in the munitions containment means and properly interact with the munitions deployment device (so that they may be fired by the device). In particular, in addition to simply enabling munitions of different sizes to fit in the munitions containment means, the adapter may also be operable to identify the presence of a munition, the identity and characteristics of same, and relay this data to the munitions deployment means when queried.

In an eleventh embodiment of the present invention, the system for remotely monitoring an environment and selectively deploying munitions according to the first through tenth embodiments above is provided, further comprising a computer program product operable to run on the first and/or second computer processing means, comprising:

(1) application program code operable to determine the types of munitions available in the system;

(2) application program code operable to receive sensor data and command data;

(3) application program code operable to analyze the sensor data and command data so as to determine correspondence of same with the available types of munitions in the system, such that a determination of whether munitions are available in the system to address the detected threat, and if so, what type of munitions are available;

(4) application program coder operable to compute a munitions availability and fireability report (i.e., a report detailing the types of munitions available to be fired, the correspondence of same to the detected threat, and the options to the user concerning which munitions may be fired), based on the sensor data, detected munitions in the system, and the correspondence of same as computer above;

(5) application program code operable to transmit the munitions availability and fireability report to the OCU and/or the munitions deployment device;

(6) application program code operable to compile fire command data, and execute transmission of same from the OCU to the munitions deployment device(s);

(7) application program code operable to compute an executable firing command at the munitions deployment device based on the received fire command data from the OCU; and

(8) application program code operable to transmit an executable firing command to the munitions initiation means, enabling the munitions initiation means (such as a stationary or movable firing pin or electrical initiator) to initiate firing the desired munition.

### BRIEF DESCRIPTION OF THE DRAWINGS

FIG. 1 is perspective view of a preferred embodiment of the munitions deployment device of the present invention, illustrating a round shaped munitions deployment device having the munitions initiating means in a rotating carousel-like configuration, with claymore style rounds mounted on mounts (ledges) disposed on the exterior of the device body.

FIG. 2 is a perspective view of a portion of the munitions deployment device illustrated in FIG. 1, illustrating the interior structure of the device body comprising a motorized rotating base upon which the munitions initiation means (in this case an electrically activated firing pin) is disposed.

FIG. 3 is a perspective view of the munitions deployment device of the present invention, illustrating a triangular-shaped embodiment of said device, with claymore style mines mounted on the exterior of the device body.

FIG. 4 is a side view of the munitions deployment device shown in FIG. 3, illustrating a preferred embodiment of the present invention wherein an acoustic sensor (i.e., a “speaker/microphone”), and a PIR sensor (passive infrared), is disposed on the munitions deployment device.

FIG. 5 is a top view of the munitions deployment device shown in FIG. 3, illustrating the configuration of the munitions containment means (i.e., launch tubes) within the device body, and wherein the claymore style mines mounted on the exterior of the device body are non-lethal claymores.

FIG. 6 is a perspective view of a preferred installation configuration of the munitions deployment device of the present invention, wherein the munitions deployment device is mounted on a tripod, to enable ease of deployment in the field.

FIG. 7 is a perspective view of a preferred embodiment of the munitions deployment device of the present invention, wherein the munitions deployment devices are provided in a rectangular configuration, and may be connected in series in a tray/base as desired to provide any desired scalability.

FIG. 8 is a perspective view of generic munition capable of being deployed in the system of the present invention, wherein a RFID/smart chip is disposed in the base of the munition to enable communication with the first and second computer processing means of the system. In particular, the disposition of such RFID/smart chips in munitions deployed in the system enables the computer processing means of the system to identify the type and status of each munition disposed in each munitions containment means.

FIG. 9 is a perspective view of the munitions deployment device of the present invention, as illustrated in FIG. 6, wherein a plurality of such munitions deployment devices are linked together via wired connections in a daisy-chain configuration.

FIG. 10 is a perspective view of the munitions deployment devices shown in FIG. 7, illustrating the configuration of the base of the device body, wherein the device body comprises one or more docking interfaces to enable installation of removal of additional munitions deployment devices.

FIG. 11 is a perspective view of the munitions deployment device of the present invention, further illustrating a conventional 40 mm grenade, and the adapter of the present invention provided to enable the placement of the grenade in the munitions containment means of the munitions deployment device shown.

FIG. 12 is a block diagram (1) illustrating the connectivity of the elements of the system of the present invention.

FIG. 13 is a perspective view of the munitions deployment device of the system of the present invention deployed on a mobile robotic vehicle (3).

FIG. 14 is a perspective view of the munitions deployment device of the present invention mounted upon a tripod, illustrating the embodiment wherein a wireless communications means is provided to wirelessly link the device to the system.

FIG. 15 is a perspective view of a munitions deployment device of the present invention, illustrating a preferred embodiment wherein various levels of munitions containment means (i.e., cartridges), with different possible launch trajectories, are removably disposed within the device body.

FIG. 16 is a partial cut away perspective view of a munitions cartridge and partial perspective view of the electrical initiation means of the munitions deployment device, illustrating the relationship thereof before full insertion of the munitions cartridge into the munitions deployment device.

FIG. 17 is a partial cut away perspective view of a munitions cartridge and partial perspective view of the electrical initiation means of the munitions deployment device, illustrating the interaction thereof, which enables alignment of the munitions primers with the electrical initiator.

FIG. 18 is a cross-sectional view of the munitions cartridge and device electrical initiations means illustrated in FIGS. 15-17, illustrating the connectivity thereof after insertion of the munitions cartridge into the deployment device.

FIG. 19 is a upside down perspective view of the munitions cartridge in attachment with the electrical initiation means, as illustrated in FIG. 18.

### DETAILED DESCRIPTION OF THE INVENTION

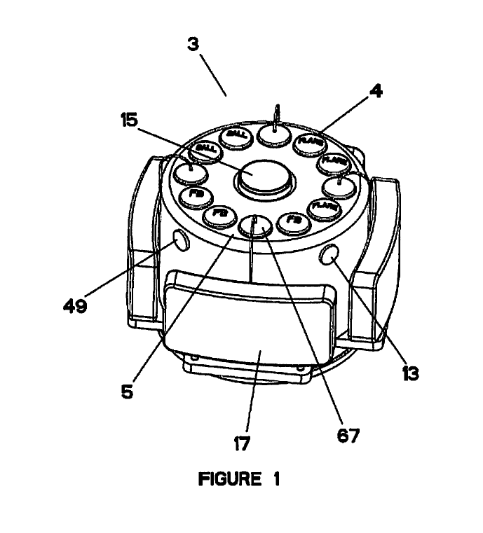

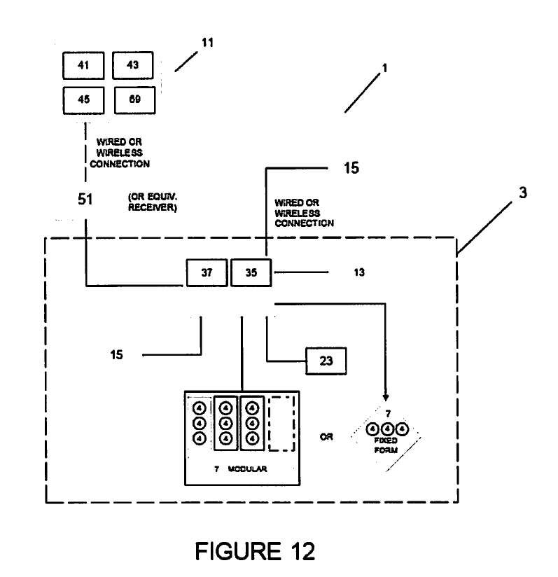

As called for in the first embodiment herein, and as illustrated in FIGS. 1 and 12, the present invention provides a system 1 for remotely monitoring an environment and selectively deploying munitions. In particular, as illustrated in FIG. 12, the system 1 of the present invention is comprised of one or more sensors 13 capable of monitoring selected environments, and one or more munitions deployment devices 3 disposed in the selected environment(s). These sensors 13 communicate data directly to an operator control unit (OCU) 11, or to the OCU via a munitions deployment device 3 or network bridge (not shown, but may be any conventional network bridge device). This sensor data is then communicated to a user via human-computer interface, such as any conventional graphical user interface (e.g., video screen), enabling a user to selectively deploy munitions disposed in or in communication with the munitions deployment device(s) 3 of the system 1. Deployable munitions 4 include, but are not limited to, non-lethal munitions such as smoke canisters, fog canisters, flares (both ground for location and air signal like a parachute round), camera recon rounds, and mini-UAV's, as well as all forms of lethal munitions.

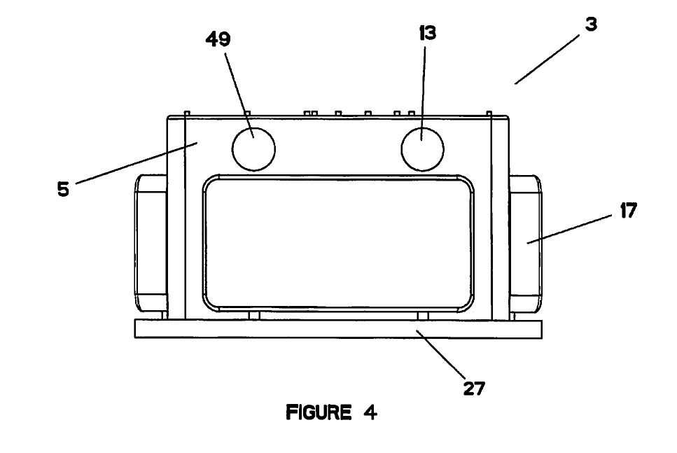

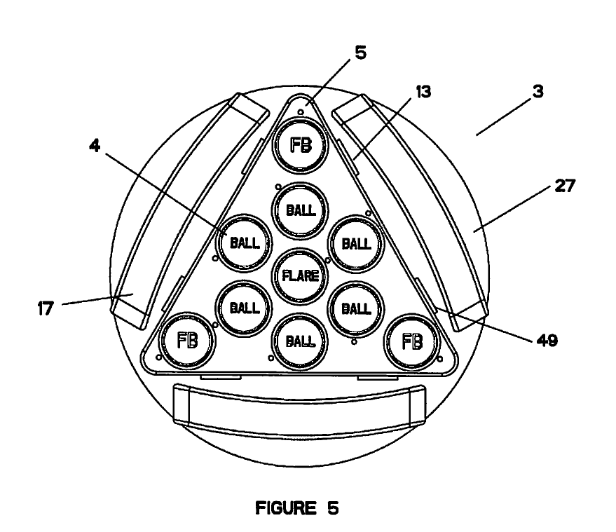

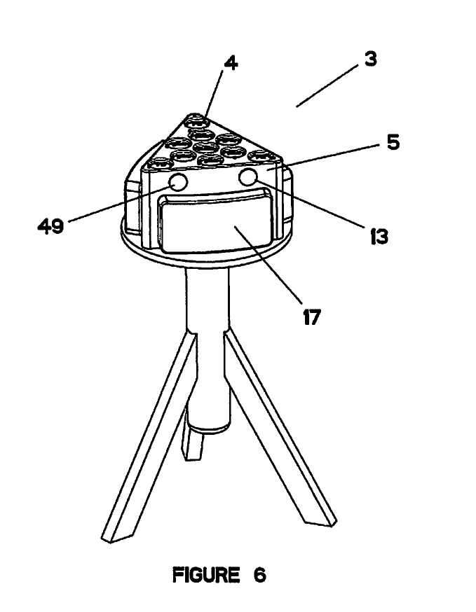

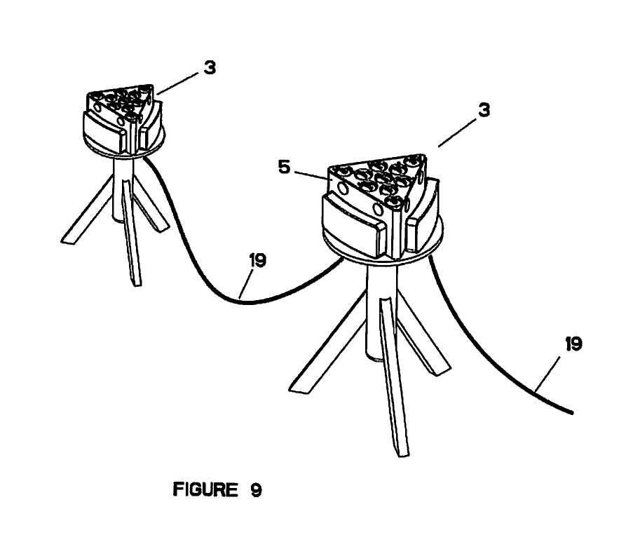

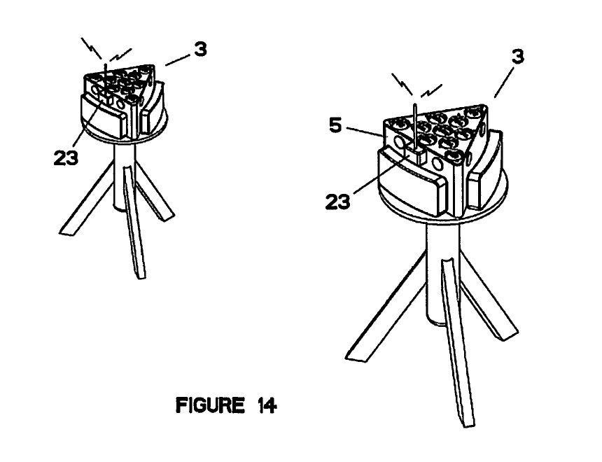

Specifically, as illustrated in FIGS. 1-7 and 9-10, the system 1 of the present invention is comprised of one or more munitions deployment devices 3 operable to selectively deploy one or more munitions 4. These munitions deployment devices 3 are generally comprised of a deployment device body 5. As illustrated in FIGS. 1, 3 and 10, these devices preferably have a round, triangular or rectangular configuration. However, the configuration of these devices 3 is not limited, as long as munitions disposed therein may be detected by the system and selectively deployed. Furthermore, when the system comprises a plurality of munitions deployment devices 3, the devices 3 may be connected in a daisy-chain (serial) configuration, as illustrated in FIG. 9, or wirelessly as illustrated in FIG. 14.

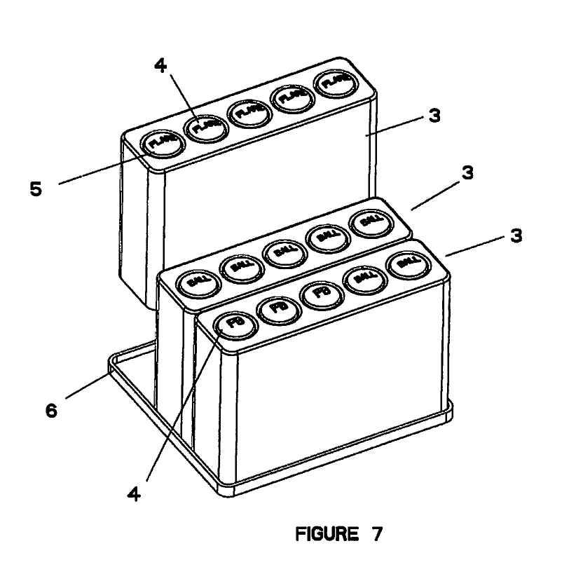

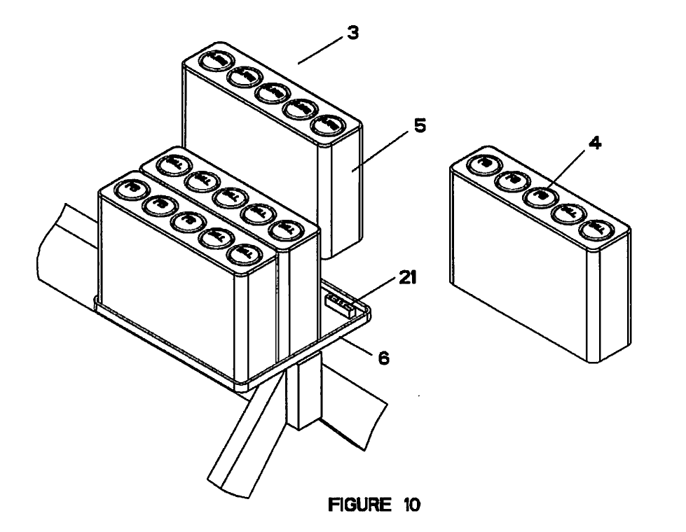

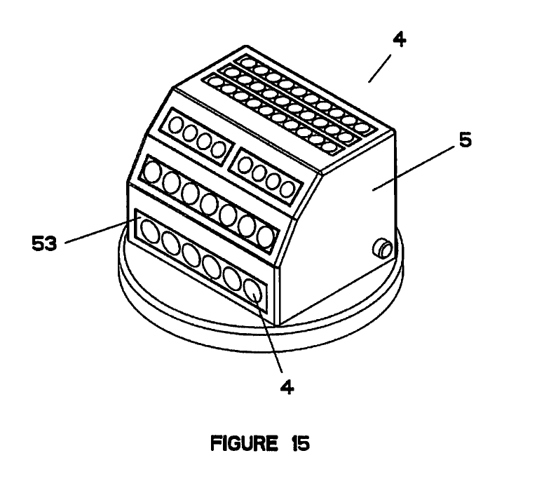

Or, as shown in FIGS. 7 and 10, a plurality of munitions deployment devices 3 may be connected in series via a base 6 having a plurality of docking interfaces 21 disposed thereon, providing ease of addition or removal of devices 3 at will. Alternatively, as illustrated in FIG. 15, a single device 3 may be configured so as to comprise one or more munitions cartridges 53. These munitions cartridges 53 may be fixed within the device, such that each munition 4 can be loaded into the cartridge. However, preferably, the cartridges 53 are removable, such that preloaded cartridges can be quickly and easily inserted and removed from the device 3, depending on the types of munitions desired.

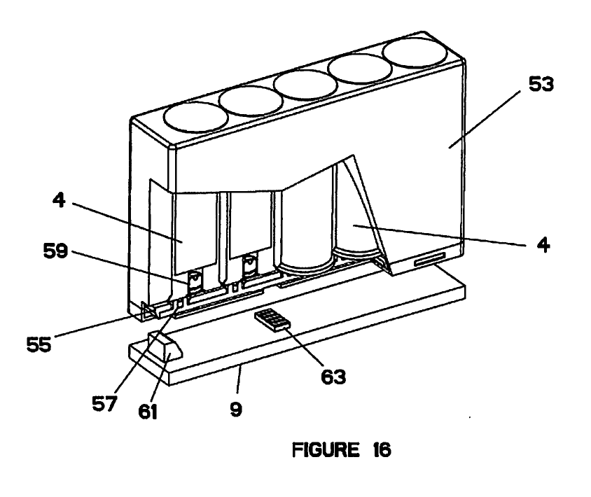

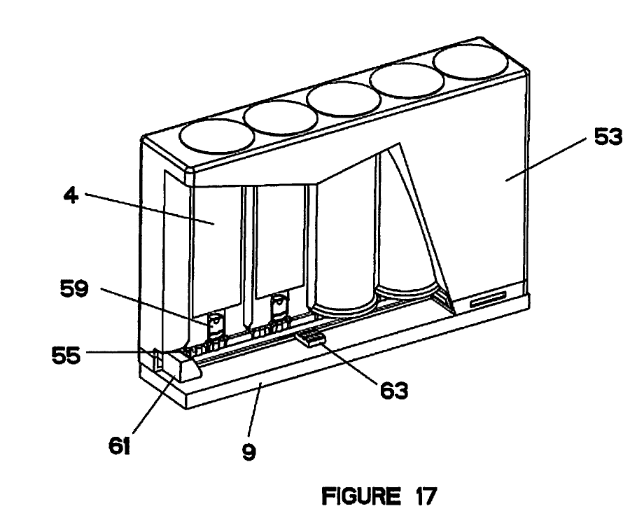

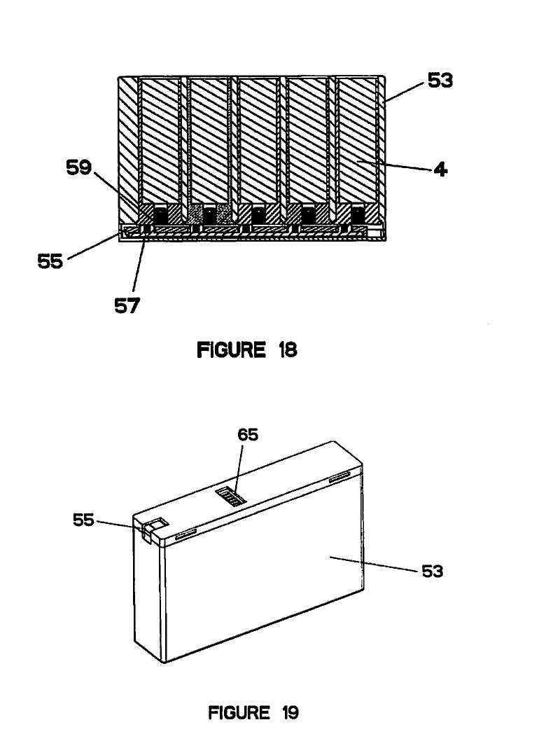

In a preferred embodiment, as illustrated in FIGS. 16, 18 and 19, the munitions cartridge 53 is designed such that a spring loaded primer safety mechanism 55 slides the electrical primer initiators 57 into a non-aligned position with regards to the munitions primers 59. Then, as illustrated in FIG. 17, when the munitions cartridge 53 is inserted into the device 3, the spring loaded primer safety mechanism 55 slidably interacts with a block 61 disposed on the munitions initiation means 9, so as to slide the electrical primer initiators 57 into alignment with the munitions primers 59 and allow electrical connection of the cartridge 53 at cartridge connection 65 with the munitions initiation means 9 via the electrical contact 63.

In an alternative embodiment, as illustrated in FIG. 14, a plurality of munitions deployment devices 3 may be electronically networked together to make use of the limited size of the system, thereby providing virtually unlimited scalability. This scalability allows smaller units (devices 3) to act as larger arrays. Communication protocol and encryption systems and methods are preferably employed in such an electronically networked system, to prevent electronic intrusion and commandeering of the system by hostile forces.

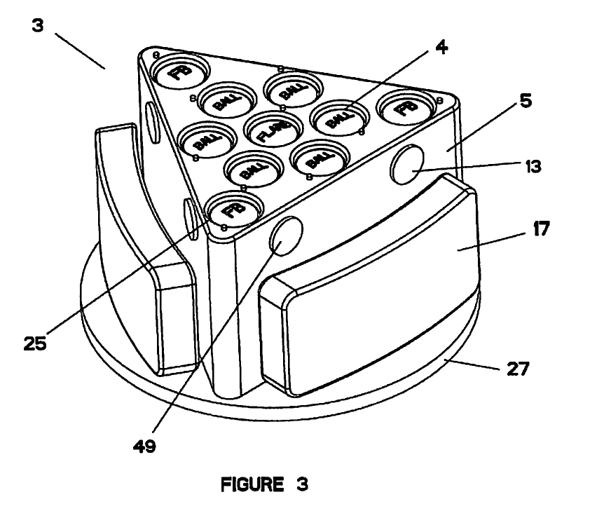

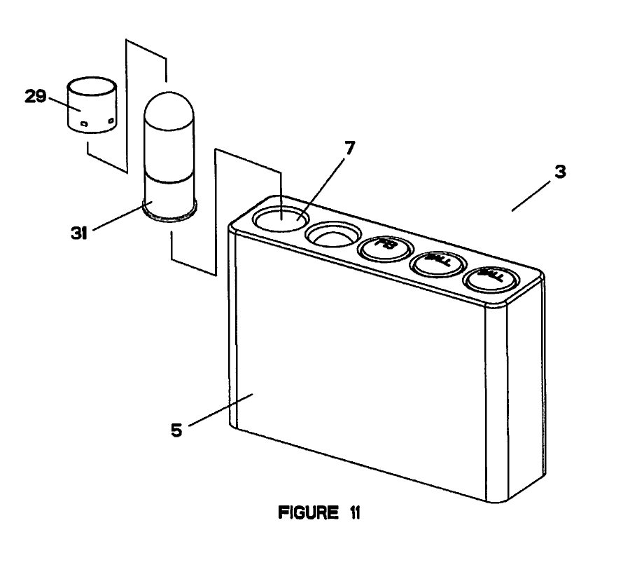

The device body 5 comprises one or more munitions containment means 7, as illustrated in FIG. 11, disposed in or in communication with the device body 5. For example, as illustrated in FIG. 3, munitions 4 may be contained in launch tubes (acting as the munitions containment means), as well as mounted on ledges 27 disposed on the device body 5 (such as are the claymore mines 17 shown). Specialized munitions may be designed to fit in the munitions containment means 7. Alternatively, the munitions containment means 7 may be designed to accommodate standard size fielded rounds.

In either event, as illustrated in FIG. 11, an adapter means 29 capable of adapting the size of the munitions containment means 7 to the munitions used may be provided. For example, where the munitions containment means is a slot which is designed to support a round-shaped specialized (non-fielded sized) munition, an adapter may be used to support (adapt) the munitions containment means to the fielded rounds (such as, for example, 40 mm grenades). This adapter, as illustrated in FIG. 11, enables standard munitions, such as the grenade 31 shown in FIG. 11, to be fitted in munitions containment means 7 that would otherwise not accommodate same, and enable the munitions to properly interact with the munitions deployment device 3 (i.e., enable the type of munitions to be identified, and the presence thereof detected).

In order to perform the above mentioned functions, the adapter 29 preferably comprises an ID chip, or some similar means, which enables the adapter 29 to identify the munitions inserted in the adapter. This ID chip or similar means would further enable the adapter 29 to communicate with the munitions deployment device 3, so to enable the identification of type and presence of munitions loaded in the specific munitions containment means 7.

For instance, if the generic (or a special) slot (munitions containment means) is about 42 mm or so, then a standard, fielded round may be deployed in the system via an adapter that latches/rests/screws into the munitions containment means. As described above, such an adapter 29 preferably comprises an id (identification) feature or chip able to communication with the system. The 42 mm grenade should clear the flange on the cartridge case and provide a place for the adapter to hold the round in, while a separate latch feature may hold the adapter 29 in the munitions containment means 7 to ensure secure transit and anti-rotation during firing of a rifled round. These adapters may be smooth-bored (for firing, for example, flares and rounds that don't need spin), or rifled for firing munitions that must be spun to fly well and arm the fuzes.

Although not specifically illustrated in FIG. 12, a first data receiving and transmission means 35 is disposed in or adjacent to the deployment device body 5 (which is generally described in FIG. 12 as “wired or wireless”). The first data receiving and transmission means 35 may be any conventional means of receiving and transmitting data, including wired receivers, wireless communications means, and should not be limited, as long as the desired objective of transmitting and receiving data may be accomplished.

Further, each munitions deployment device 5 further comprises a first computer processing means 37 in communication with the first data receiving and transmitting means 35. This first computer processing means 37 may likewise be any conventional computer processing means, such as a conventional Intel® microprocessor. The computational requirements for such a device are generally limited. Therefore, a fairly simple microprocessor may be used. Alternatively, a simple logic controller may be used.

The munitions deployment device 5 further comprises one or more munitions initiation means 9 in communication with the first computer processing means 37, and in communication with or disposed adjacent to the munitions containment means 7. The munitions initiation means 9 must be capable of initiating munitions disposed within or in communication with the munitions containment means 7. For example, an electrically actuated firing pin may be utilized as the munitions initiation means 9. The munitions initiation means 9 are controllable by a user via the OCU 11, or are programmable such that initiation of the munitions disposed in the munitions containment means may be restricted to desired times and/or conditions.

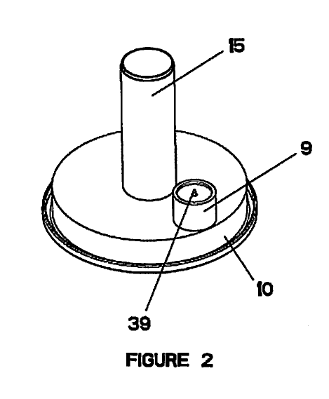

As shown in FIG. 2, a firing pin type solenoid 39 may be utilized, or other electronic or pyrotechnic launch means may be disposed adjacent each slot (munitions containment means). Some systems, for example, may have a rotating carousel, similar to a slide projector, to bring the munition or adapter “in-line” with a single firing pin. In the preferred embodiment shown in FIG. 2, such an electrically actuated firing pin 39 is mounted on a rotating carousel-like base 10, enabling the firing pin 39 to be selectively disposed adjacent a desired munition 4, so as to initiate same upon command. This configuration reduces cost, weight, and complexity, as only one munitions initiation means 9 is needed.

Alternatively, at a location on or within the device body 5 (such as the base 10), an electric solenoid firing pin is disposed. When firing of a specific munition 4 is desired, the shuttle will rotate the device body 5 so as to dispose the desired munition adjacent the firing pin. The system will then activate the electric solenoid firing pin, thereby performing the necessary firing command sequence, and launching/firing the munition. As with the above rotating firing pin type design, the weight and complexity of a device wherein the device body is rotated adjacent a fixed firing pin is likewise minimized by using a single electric solenoid firing pin and rotary table (shuttle) to bring the munition in-line with the firing pin.

There are, however, certain configurations that may require non-lethal or lethal claymore munitions, or other non-standard accessories that cannot be activated/initiated by a firing pin. In such case, an M42 or similar munitions initiation adapter 67 fitted with a smart chip and shock tube may be installed on/disposed in one of the munitions containment means 25, or a dedicated accessory slot sized to minimize space.

Alternatively, as illustrated in FIG. 7, an array of square or rectangular sub-devices 3 can be “docked” on a base 6 that has docking connectors and a single processor to control all units assembled to it. However, various other configurations of the munitions deployment means, such as the triangular configuration shown in FIG. 3, and the rectangular configuration shown in FIG. 10, would call for a different munitions initiation means arrangement. For example, the munitions may be electrically actuated, thereby eliminating the need for a firing pin mechanism. Or, in the case of the rectangular configuration, the firing pin mechanism may be mounted on a rotating belt structure to allow placement of the firing pin beneath any munitions containment means. Importantly, the configuration of the munitions initiation means 9 should not be limited, as it is dependent upon the configuration of the device body 5 and disposition of the munitions containment means 7 therein/thereon.

Alternatively, the munitions initiation means 9 may be preprogrammable, such that initiation of the munitions 4 disposed in the munitions containment means 7 or cartridges 53 may be programmed to automatically initiate upon detection of predetermined environmental variables transmitted to the system by the sensors 13. In another preferred embodiment, the system 1 of the present invention may be programmed to prevent initiation of certain munitions, depending upon the situation. For example, if a non-lethal threat is detected, the computer program product of the present invention may be programmed to prevent deployment of lethal munitions disposed on the system. This involves executing a computer executable command operable to prevent transmission of firing commands to the munitions initiation means at predetermined times/situations.

The second main component of the system of the present invention is the operator control unit (OCU) 11. The OCU 11 enables a user to communicate with the munitions deployment means and sensor means, i.e., transfer data between same. The OCU is comprised of a human-computer interface (such as conventional switches, joysticks, keyboards, etc.), and a second computer processing means 41. Like the first computer processing 37 means, the second computer processing mean 41 may be any conventional computer processing means, such as a conventional microprocessor.

However, unlike the first computer processing means 37, the second computer processing means is operable to run (execute) a computer software program (application) operable to analyze data received from the sensors 13, determine the type and status of munitions 4 available in the system, determine the type and status of detected threats, determine the suitable munitions to be deployed against the detected threats, and compile and transmit command data (such as firing command data to initiate the firing of selected munitions) to the appropriate munitions deployment devices 3 concerning same. Therefore, a microprocessor capable of running such a program is required.

In addition, the OCU 11 further comprises data storage means 41 in communication with the second computer processing means. This data storage means 41 may be any suitable computer usable or computer readable medium. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

The OCU 11 also comprises a second data receiving and transmission means in communication with the second computer processing means. This second data receiving and transmission means, like the first data receiving and transmission means, may be any conventional means of receiving and transmitting data. For example, a wired receiver/transmitter may be utilized. Alternatively, a secure wireless communication device, such as an encryption protected wireless LAN or network device, or a secure radio communication device, may be utilized. The communication means should not be limited, as long as the desired objective of transmitting and receiving data may be accomplished

As mentioned above, and as illustrated in FIGS. 1, 4, 6 and 12, the system 1 is comprised of one or more sensors 13 disposed in communication with the munitions deployment device 3 and/or the OCU 11. These sensors 13 are operable to detect environmental changes which indicate the presence of threats to the secured environment. The sensors 13 may be comprised of, in particular, of one or more of chemical, biological, motion, RADAR, LIDAR, and infrared sensors. However, the sensors 13 should not be limited, but rather may be tailored to the environment to be observed.

In a further preferred embodiment of the present invention, as illustrated in FIGS. 1 and 2, the munitions deployment device 3 may comprise a video or still camera means 15 in communication with the munitions deployment device 3 and/or OCU 11. As illustrated, the video or still camera means 15 may be disposed directly on the munitions deployment device 3. Alternatively, the video or still camera means 15 may be disposed remotely from the device 3, in communication with the munitions deployment device 3, network bridges (not illustrated, but which may be any conventional wireless bridge device) and/or the OCU 11, etc. Essentially, placement of the video or still camera means 15 is not limited, as long as the disposition thereof enables surveillance of the desired environment.

A fourth major component of the system of the present invention is a computer program product, as mentioned above, operable to run on the first or second computer processing means 37, 41. The computer program product (i.e., computer program application) enables the system 1 to receive sensor data from the sensors 13, analyze the sensor data, determine the appropriate action to take and/or provide a report to the user concerning what suitable munitions are available for deployment, and formulate and transmit executable command data from the OCU to the munitions deployment means. These firing commands may be preprogrammed (so as to be automatically carried out by the system based on the threat detected), or require authorization by a user prior to execution thereof.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on either of the computer processing means 37 and 41 of the present invention, partly on each, or on a remote computer or server. In the latter scenario, the remote computer or server may be connected to the system through a local area network (LAN) or a wide area network (WAN), or the connection may be made to an external computer (for example, through the Internet using an Internet Service Provider).

In particular, the computer program of the present invention is operable to perform the following general functional steps:

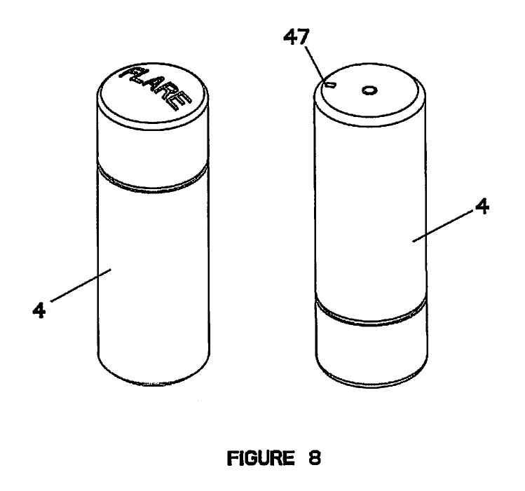

(1) Determine the types of munitions available in the system. For example, the munitions deployment devices 3 comprise a means of detecting the presence and type of munition contained in each munitions containment means. This may be achieved by disposing an RFID/smart chip 47 in each munition, as illustrated in FIG. 8.

(2) Receives the sensor data from the sensors 13, and command data from the OCU 11.

(3) Analyzes the sensor data and command data to determine compatibility of same with the available types of munitions 4 in the system 1.

(4) Computes a munitions availability and fireability report. This report includes data concerning the types of munitions available to be fired, the correspondence of same to the detected threat, and the options to the user concerning which munitions may be fired.

(5) Transmits the munitions availability and fireability report to the OCU 11.

(6) Computes and transmits fire command data from the OCU 11 to the munitions deployment device(s) 3.

(7) Computes and transmits a firing command executable at the munitions deployment device(s) 3 based on the received fire command data from the OCU 11; and

(8) Transmits an executable firing command to the munitions initiation means 9, enabling the munitions initiation means 9 (such as, for example, a stationary or movable firing pin or electrical initiator) to initiate firing the desired munition.

As mentioned above, to enable the functions described above, each munition 4 is preferably embedded with an ID chip or similar keying technology. After a munition 4 is initiated (fired), the munitions deployment device 3, via the computer software application described above, surveys the loaded munitions so as to take an inventory of the remaining munitions in the device 3, and the slot location of each munition. This data is transmitted from the first computer processing means 37 to the second computer processing means 41. This “ID function” allows varying levels of firing control for the different munitions loaded. For example, when the system detects that a device 3 is loaded with a mix of lethal and non-lethal munitions, the computer program application initiates a requirement for additional authorization to use the lethal rounds.

Configurability is an important element of the system of the present invention. For example, the system of the present invention can be configured to be autonomous (via preprogramming of the system), or highly controllable by a user. The ID function (which enables identification of munitions disposed in the munitions deployment device) permits direct access to the slot (munition containment means) with the desired round. Further, safeing methods and means are incorporated within the system to prevent/minimize drop, tamper, accidental firing, etc.

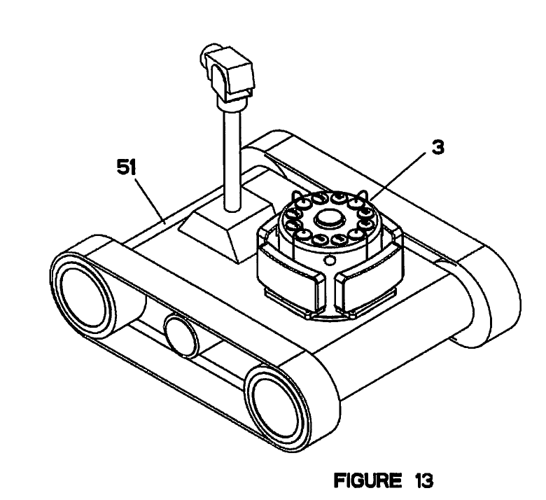

In addition to stationary placements of the system, as illustrated in FIG. 13, the system 1 may be disposed in mobile and/or robotic applications 51. For example, the system can be deployed on ships, manned motorized vehicles, robotic vehicles, trains, etc. In a further embodiment of the present invention, the system can be configured as solely a self protection system (including, for example, vertical firing of non-lethal munitions to prevent life-threatening injuries). In such an embodiment, a remote operator sees or senses an approaching hostile entity via the sensors 13 and/or video or still camera means 15, and may verbally warn the entity to retreat via the speaker/microphone 49. As the hostile entity moves closer to the device 3, the remote operator can choose to fire one or a series of non-lethal munitions as deterrents (such as a flash bang over head, and then send up an air burst rubber ball round). A side mounted non-lethal claymore could be the final, most direct non-lethal deterrent to the hostile force. Lethal munitions may finally be deployed as a last resort.

In a further embodiment of the present invention, wherein the system is disposed on a robotic vehicle 51 as shown in FIG. 13, the system further comprises a signaling application. Specifically, should the robotic vehicle 51 break down out of direct sight of the operator, the computer software application functions to initiate a signal or time out electronically, and execute application program code operable to transmit a fire/launch command. This command then, initiates the launch of a non-lethal smoke canister, flash-bang round, and/or high/low altitude flares to alert the user of its location. The signaling means may also be programmed to deploy one or more smoke canisters to fog the surrounding area so that users can retrieve the robot while obscured from, for example, a sniper attack.

In a preferably embodiment, upon installation and/or activation of the device 3, the system 1, via the computer software program, performs a survey in order to log and store the location and types of munitions available within the system, and provide munitions inventory information (via a report thereof) to the user. It may be determined that special authorization may be needed to use certain munitions (such as lethal munitions). The embedded chip RFID/smart chip 47 will inform the system of same, thereby initiating the computer software program to require additional firing commands/authorization data if a particular munition is selected for firing.

Those skilled in the art will recognize that the system and computer program product of the present invention have many applications, and that the present invention is not limited to the representative examples disclosed herein. Although illustrative, the embodiments disclosed herein have a wide range of modification, change and substitution that is intended, and in some instances some features of the present invention may be employed without a corresponding use of the other features.

Moreover, the scope of the present invention covers conventionally known variations and modifications to the system components described herein, as would be known by those skilled in the art. Accordingly, it is appropriate that the appended claims be construed broadly and in a manner consistent with the scope of the invention.

### LIST OF DRAWING ELEMENTS

1: system for remotely monitoring an environment and selectively deploying munitions
3: munitions deployment device
4: munitions
5: deployment device body
6: base
7: munitions containment means
9: munitions initiation means
10: rotating carousel-like base
11: operator control unit (OCU)
13: sensors
15: video or still camera means
17: claymore style round
19: wired connector
21: docking interfaces
23: wireless communication means
25: launch tubes
27: device body ledge
29: adapter
31: grenade
33: munitions identification communication means
35: first data receiving and transmission means
37: first computer processing means
39: firing pin type solenoid
41: second computer processing means
43: data storage means
45: second data receiving and transmission means
47: RFID/smart chip
49: speaker/microphone
51: robotic vehicle
53: munitions cartridge
55: spring loaded primer safety mechanism
57: electrical primer initiators
59: munitions primers
61: block
63: electrical contact
65: cartridge connection
67: munitions initiation adapter
69: human-computer interface

What is claimed is:

1. A system for remotely monitoring an environment and selectively deploying munitions is provided comprising:
(a) one or more munitions deployment devices operable to selectively deploy one or more munitions, said munitions deployment means comprising:
(i) a deployment device body;
(ii) munitions containment means disposed in or in communication with the deployment device body;
(ii) a first data receiving and transmission means disposed in or adjacent to the deployment device body;
(iii) a first computer processing means in communication with the data receiver means;
(iv) one or more munitions initiation means in communication with the computer processing means, and in communication with or disposed adjacent to the munitions containment means, so to be capable of initiating munitions disposed within or in communication with the munitions containment means;
(b) a operator control unit (OCU) comprising:
(i) a second computer processing means;
(ii) a data storage means in communication with the second computer processing means;
(iii) a second data receiving and transmission means in communication with the second computer processing means; and
(iv) a human-computer interface;
(c) one or more sensors disposed in communication with the munitions deployment device and/or the OCU, said sensors operable to detect one or more of status and changes in environment and personnel within detection range of the sensors.

2. The system for remotely monitoring an environment and selectively deploying munitions of claim 1, further comprising:
(d) a video or still camera means in communication with the munitions deployment device and/or OCU,
wherein a user may receive imagery concerning the environment of interest from the video or still camera means.

3. The system for remotely monitoring an environment and selectively deploying munitions of claim 1, further comprising:
an audio and/or video communication means disposed on or in communication with the munitions deployment means, and in communication with the OCU,
wherein a system user may utilize the audio and/or video communication means to communicate audible and/or visual messages, warnings, etc., to hostile or non-hostile personnel.

4. The system for remotely monitoring an environment and selectively deploying munitions of claim 1, wherein the munitions containment means comprises one or more of a launch tube, retaining bracket and mount.

5. The system for remotely monitoring an environment and selectively deploying munitions of claim 1, wherein the first data receiving and transmission means is wired or wireless.

6. The system for remotely monitoring an environment and selectively deploying munitions of claim 1, wherein first and second computer processing means are comprised of any conventional microprocessor and/or logic device.

7. The system for remotely monitoring an environment and selectively deploying munitions of claim 1, wherein the munitions initiation means comprise one or more of electrical initiation means and mechanical initiation means (such as a firing pin structure), such that the munitions initiation means are controllable by a user via the OCU, or are programmable such that initiation of the munitions disposed in the munitions containment means may be restricted to desired times and/or conditions.

8. The system for remotely monitoring an environment and selectively deploying munitions of claim 1, wherein the system comprises a plurality of munitions deployment devices connected in a daisy-chain (serial) configuration, or a plurality of munitions deployment devices in independent communication with the OCU.

9. The system for remotely monitoring an environment and selectively deploying munitions of claim 1, wherein the sensor means comprises one or more of chemical, biological, motion, RADAR, LIDAR, acoustic, seismic, magnetic, mechanical (such as trip wires), laser (light beam) and infrared sensors.

10. The system for remotely monitoring an environment and selectively deploying munitions of claim 1, further comprising adapter means capable of adapting the size of the munitions containment means to accommodate a standard (fielded) munition.

11. The system for remotely monitoring an environment and selectively deploying munitions of claim 1, further comprising a computer program product comprising:
(1) application program code operable to determine types of munitions available in the system;
(3) application program code operable to receive sensor data and command data;
(3) application program code operable to analyze the sensor data and command data so as to determine compatibility of same with the available types of munitions in the system;
(4) application program code operable to compile a munitions availability and fireability report, said report comprising data concerning the types of munitions available to be fired, the correspondence of same to the detected threat, and options available to the user concerning which munitions may be fired;
(5) application program code operable to transmit the munitions availability and fireability report to the OCU;
(6) application program code operable to compute and transmit fire command data from the OCU to the munitions deployment device(s);
(7) application program code operable to compute a firing command executable at the munitions deployment device based on the received fire command data from the OCU; and
(8) application program code operable to transmit the executable firing command to the munitions initiation means, enabling the munitions initiation means to initiate firing the desired munition.
